(19) United States
(12) Patent Application Publication
(10) Pub. No.: US 2024/0131498 A1
(43) Pub. Date: Apr. 25, 2024

(54) SULFUR-RESISTANT METAL PROMOTED SMALL PORE ZEOLITE CATALYSTS

(71) Applicant: BASF CORPORATION, Florham Park, NJ (US)

(72) Inventors: Jia Di Zhang, Shanghai (CN); Wen-Mei Xue, Iselin, NJ (US); Xiaofan Yang, Iselin, NJ (US); Weiyong Tang, Iselin, NJ (US); Burcu Bayram, Iselin, NJ (US); Yu Fen Hao, Shanghai (CN)

(73) Assignee: BASF CORPORATION, Florham Park, NJ (US)

(21) Appl. No.: 18/277,908

(22) PCT Filed: Feb. 18, 2022
(86) PCT No.: PCT/CN2022/076833

§ 371 Date: Aug. 17, 2023

(30) Foreign Application Priority Data
Feb. 19, 2021 (WO) PCT/CN2021/076917

(51) Int. Cl. B01J 29/76; B01D 53/94; B01J 23/42; B01J 29/90; B01J 35/57; B01J 35/61; B01J 35/77; B01J 37/00; B01J 37/02; B01J 38/12; F01N 3/20; F01N 3/28

(52) U.S. Cl. CPC B01J 29/763; B01D 53/9418; B01D 53/944; B01J 23/42; B01J 29/90; B01J 35/57; B01J 35/612; B01J 35/77; B01J 37/0036; B01J 37/0215; B01J 38/12; F01N 3/2066; F01N 3/2803; B01D 2255/1021; B01D 2255/20761; B01D 2255/50; B01D 2255/9155; B01D 2257/404; B01D 2258/012; B01J 2229/186; F01N 2370/04

(57) ABSTRACT

The present invention relates to a SCR catalytic article, comprising —a substrate and —a copper-containing small pore zeolite, having a crystal structure characterized by a decrease of unit cell volume upon sulfurization and desulfurization of less than Å³ as determined by an X-ray powder diffraction, wherein the sulfurization and desulfurization are carried out in accordance with the processes as described in the specification, and to an exhaust treatment system comprising the same. The present invention also relates to a method for determining whether a metal-promoted small pore zeolite is resistant to irreversible sulfur poisoning and a method for evaluating whether a metal-promoted small pore zeolite is qualified for resistance to irreversible sulfur poisoning.

### FIELD OF THE INVENTION

The present invention relates to sulfur-resistant metal promoted small pore zeolites, catalytic articles containing the same, and systems and methods for treating exhausts of an internal combustion engine.

### BACKGROUND OF THE INVENTION

Catalytic articles are essential for modern internal combustion engines to treat exhausts from internal combustion engines. The exhausts from internal combustion engines typically comprises particulate matter (PM), nitrogen oxides (NOx) such as NO and/or NO₂, unburned hydrocarbons (HC), and carbon monoxide (CO). Control of emissions of nitrogen oxides (NOx) is always one of the most important topics in automotive field, due to the environmentally negative impact on ecosystem, animal and plant life.

One of effective techniques for removal of NOx from internal combustion engine exhausts, particularly diesel engine exhausts, is selective catalytic reduction (SCR) of NOx with NH₃. Catalysts useful for the SCR process should be stable under high temperature hydrothermal conditions, which is for example encountered during the regeneration of a soot filter, a component of the exhaust gas treatment system used for the removal of the particle matter. Small pore zeolites, particularly metal promoted small pore zeolites have been found promising as the SCR catalysts with high NOx reduction activity over a broad temperature range and desired hydrothermal stability.

In addition to the hydrothermal aging deactivation, another significant factor impacting the performance of the SCR catalytic articles is chemical poisoning such as sulfur poisoning. Sulfur poisoning originates from the cumulative exposure of the catalyst to sulfur species in the fuel and fuel-derived sulfur-containing contaminants. Sulfur content in diesel fuel has been significantly reduced in recent years, which may be even less than 15 ppm sulfur with the introduction of Ultra-Low Sulfur Diesel (ULSD) in North America for example. However, cumulative exposure of catalysts over their lifetime in heavy duty diesel engine exhaust treatment system may amount to kilograms of sulfur. The situation could be even worse for some off-road applications or in certain regions where high sulfur diesels (>350 ppm sulfur) are not uncommon.

SCR catalytic articles may be regenerated at high temperatures, which is commonly accomplished during the regeneration of the soot filter. The NOx reduction activity of the SCR catalytic articles degraded by sulfur poisoning will be recovered significantly by the regeneration. However, a proportion of NOx reduction activity loss cannot be remedied by the regeneration, resulting in permanent sulfur poisoning damage to the SCR catalyst activity, which is also known as irreversible sulfur poisoning.

There exists a need for metal promoted small pore zeolites which provide excellent SCR performance and are resistant to the irreversible sulfur poisoning. There is another need for a method useful for simply determining whether a metal promoted small pore zeolite is resistant to the irreversible sulfur poisoning.

### SUMMARY OF THE INVENTION

In one aspect, the present invention provides a SCR catalytic article, which comprises
a substrate and thereon
a copper-containing small pore zeolite, having a crystal structure characterized by a decrease of unit cell volume upon sulfurization and desulfurization of less than 10 Å³, as determined by an X-ray powder diffraction,
wherein
the sulfurization is carried out by passing a gas stream containing 35 ppmv SO₂, 350 ppmv NO, 10 vol % O₂, 10 vol % H₂O and balanced N₂ through a Pt-containing diesel oxidation catalyst (DOC) under an inlet temperature of 650° C. for partially oxidizing SO₂ to provide a SO₂ to SO³ ratio of 30:70 and then through the SCR catalytic article under an outlet temperature of 400° C., at a space velocity of 10,000 hr⁻¹ based on the volume of the SCR catalytic article, for a period to provide 40 g/L of S exposure based on the volume of the SCR catalytic article, wherein the SCR catalytic article has been hydrothermally aged prior to the sulfurization; and
the desulfurization is carried out by passing a gas stream containing 10 vol % O₂, 8 vol % H₂O, 7 vol % CO₂ and balanced N₂ through the SCR catalytic article having been subjected to the sulfurization at a space velocity of 60,000 h⁻¹ at 550° C. for 30 minutes.

In another aspect, the present invention provides an exhaust treatment system comprising
an internal combustion engine, for example a gasoline engine or a diesel engine; and
a SCR catalytic article as described herein, located downstream of and in flow communication with the engine.

In still another aspect, the present invention provides a method for treating an exhaust stream comprising NOx, including contacting the exhaust stream with the SCR catalytic article or the exhaust treatment system as described herein.

In yet another aspect, the present invention provides use of the copper-containing small pore zeolite as described herein as a SCR catalyst.

In a further aspect, the present invention provides a method for determining whether a metal-promoted small pore zeolite is resistant to irreversible sulfur poisoning, which comprises
preparation by applying the metal promoted small pore zeolite onto a substrate to provide a SCR catalytic article;
sulfurization by passing a gas stream containing 35 ppmv SO₂, 350 ppmv NO, 10 vol % O₂, 10 vol % H₂O and balanced N₂ through a Pt-containing diesel oxidation catalyst (DOC) under an inlet temperature of 650° C. for partially oxidizing SO₂ to provide a SO₂ to SO₃ ratio of 30:70 and then through the SCR catalytic article under an outlet temperature of 400° C., at a space velocity of 10,000 hr⁻¹ based on the volume of the SCR catalytic article, for a period to provide a sulfurized SCR catalytic article with 40 g/L of S exposure based on the volume the SCR catalytic article, wherein the SCR catalytic article has been hydrothermally aged prior to the sulfurization;
desulfurization by passing a gas stream containing 10 vol % O₂, 8 vol % H₂O, 7 vol % CO₂ and balanced N₂ through the sulfurized SCR catalytic article at a space velocity of 60,000 h⁻¹ at 550° C. for 30 minutes; and
determination of the unit cell volumes of the metal promoted small pore zeolite before sulfurization and after desulfurization by an X-ray powder diffraction,
   wherein the metal promoted small pore zeolite is resistant to irreversible sulfur poisoning if the unit cell volume of the metal promoted small pore zeolite after desulfurization is lower than the unit cell volume thereof before sulfurization by less than 10 Å³.

In a further aspect, the present invention provides a method for evaluating whether a metal-promoted small pore zeolite is qualified for resistance to irreversible sulfur poisoning, which includes
providing a catalytic article comprising a substate and thereon a reference metal promoted small pore zeolite which has a minimum qualified NOx conversion recovery ratio, for example 70% or higher, upon sulfurization and desulfurization:

$$NOx Conversion Recovery Ratio ( \% ) = \frac{NOx Conversion after Desulfurization \times 100 \%}{NOx Conversion prior to Sulfurization}$$

determining the unit cell volume variation of the reference metal promoted small pore zeolite before sulfurization and after desulfurization by an X-ray powder diffraction, which is referred to as a predetermined value of unit cell volume variation;
preparing a catalytic article comprising a substate and thereon the metal promoted small pore zeolite to be evaluated;
determining the unit cell volume variation of the metal promoted small pore zeolite before sulfurization and after desulfurization at the same conditions as those for the catalytic article comprising a reference metal promoted small pore zeolite by the X-ray powder diffraction;
comparing the variation of the unit cell volume of the metal promoted small pore zeolite with the predetermined value,
   wherein the metal promoted small pore zeolite is evaluated as qualified for the resistance to irreversible sulfur poisoning if the unit cell volume variation thereof is no more than the predetermined value.

### BRIEF DESCRIPTION OF THE DRAWINGS

FIG. 1 is a graph showing the content of S residues of the copper-containing small pore zeolites according to Examples 2 and 4 upon sulfurization and desulfurization and respective atomic S/Cu ratios.

FIG. 2 is a graph showing the NOx conversions prior to sulfurization and after desulfurization, and the NOx conversion recovery ratios as tested for the catalytic articles comprising Cu/SSZ13 according to Examples 1 to 4.

### DETAILED DESCRIPTION OF THE INVENTION

The present invention will be described in details hereinafter. It is to be understood that the present invention may be embodied in many different ways and shall not be construed as limited to the embodiments set forth herein.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

The term “selective catalytic reduction” (SCR) refers to the catalytic process of reducing NOx to N₂ using a nitrogenous reductant, for example ammonia, urea, and the like.

According to one aspect of the present invention, a SCR catalytic article is provided, which comprises:
a substrate and thereon
a copper-containing small pore zeolite, having a crystal structure characterized by a decrease of unit cell volume upon sulfurization and desulfurization of less than 10 Å³, as determined by an X-ray powder diffraction,
wherein
the sulfurization is carried out by passing a gas stream containing 35 ppmv SO₂, 350 ppmv NO, 10 vol % O₂, 10 vol % H₂O and balanced N₂ through a Pt-containing diesel oxidation catalyst (DOC) under an inlet temperature of 650° C. for partially oxidizing SO₂ to provide a SO₂ to SO₃ ratio of 30:70 and then through the SCR catalytic article under an outlet temperature of 400° C., at a space velocity of 10,000 hr⁻¹ based on the volume of the SCR catalytic article, for a period to provide 40 g/L of S exposure based on the volume of the SCR catalytic article, wherein the SCR catalytic article has been hydrothermally aged prior to the sulfurization; and
the desulfurization is carried out by passing a gas stream containing 10 vol % O₂, 8 vol % H₂O, 7 vol % CO₂ and balanced N₂ through the SCR catalytic article having been subjected to the sulfurization at a space velocity of 60,000 h⁻¹ at 550° C. for 30 minutes.

As used herein, the term copper-containing small pore zeolite refers to a small pore zeolite comprising copper which is ion-exchanged or impregnated therein and/or thereon. Copper is a typical metal promoter contained in a zeolite material to enhance the performance of the zeolite material as a SCR catalyst.

The copper-containing small pore zeolite generally has a Cu content of at least 0.1 wt %, calculated as CuO and based on the total weight of the copper-containing small pore zeolite on a volatile-free basis. In some embodiments, the Cu content is in the range of 0.1 wt % to 20 wt %, for example 0.5 wt % to 17 wt %, 2 wt % to 15 wt %, 2 wt % to 10 wt %, or 2 wt % to 7 wt %, calculated as CuO and based on the total weight of the copper-containing small pore zeolite on a volatile-free basis in each case. In some other embodiments, the Cu content may be expressed as the ratio of Cu to framework aluminium within the copper-containing small pore zeolite. For example, the copper-containing small pore zeolite has a copper to framework aluminium molar ratio in the range of 0.1 to 0.5, for example 0.25 to 0.5 or 0.30 to 0.50.

The term “small pore zeolite” refers to a zeolite having pore openings which are smaller than about 5 Angstroms (Å).

In some embodiments, the small pore zeolite may be a small pore 8-ring zeolite. The term “8-ring zeolite” refers to a zeolite having 8-ring pore openings. Some 8-ring zeolites may have double-six ring (d6r) secondary building units in which a cage like structure is formed resulting from the connection of double six-ring building units by 4-rings. Exemplary small pore 8-ring zeolites include framework types AEI, AFT, AFX, CHA, EAB, EMT, ERI, FAU, GME, JSR, KFI, LEV, LTL, LTN, MOZ, MSO, MVWV, OFF, SAS, SAT, SAV, SBS, SBT, SFW, SSF, SZR, TSC and WEN.

In some particular embodiments, the small pore zeolite has a framework type selected from the group consisting of AEI, AFT, AFX, CHA, EAB, ERI, KFI, LEV, SAS, SAT and SAV. In some further embodiments, the small pore zeolite has a framework type selected from the group consisting of AEI, AFT, AFX and CHA. In certain embodiments, the small pore zeolite has the CHA framework type.

More particularly, the small pore zeolite is selected from zeolites having the CHA framework type and may for example be an aluminosilicate zeolite, a borosilicate zeolite, a gallosilicate zeolite, a SAPO zeolite, an ALPO zeolite, a MeAPSO zeolite, or a MeAPO zeolite. Suitable zeolites having the CHA framework type may include, but are not limited to natural chabazite, SSZ-13, SSZ-62, zeolite K-G, Linde D, Linde R, LZ-218, LZ-235, LZ-236, ZK-14, SAPO-34, SAPO-44, SAPO-47, CuSAPO-34, CuSAPO-44, CuSAPO-47 and ZYT-6.

In some embodiments, the small pore zeolite is selected from aluminosilicate zeolites. The aluminosilicate zeolites may have various silica to alumina ratios over a wide range. In some embodiments, the silica to alumina molar ratio (SAR) may be in the range of 2 to 300, for example 5 to 250, 5 to 200, 5 to 100, or 5 to 60.

In some particular embodiments, the small-pore zeolite is selected aluminosilicate zeolites having the CHA framework type. The aluminosilicate zeolites having the CHA framework type may have a silica to alumina ratio in the range of 2 to 200, for example 5 to 150, 5 to 100, 5 to 100, or 5 to 80. In some further embodiments, the silica to alumina ratio may be in the range of 5 to 60, for example 10 to 60, 11 to 50, 11 to 40, or 12 to 35.

The small pore zeolite may be natural or synthetic, preferably synthetic zeolites. As one of commercially available synthetic forms of aluminosilicate zeolites having the CHA framework type, SSZ-13 will be particularly mentioned in the present invention, which may also be synthesized in accordance with the process as described for example in U.S. Pat. No. 4,544,538 A, which is hereby incorporated by reference.

Generally, the small pore zeolites useful in the present invention may have an average crystal size varying over a broad range, for example 0.05 to 5 microns, 0.05 to 1 microns, 0.5 to 2 microns, or 0.8 micron to 1.5 microns, as measured by scanning electron microscopy (SEM).

The copper-containing small pore zeolites useful in the present invention preferably have a crystal structure characterized by a decrease of unit cell volume upon sulfurization and desulfurization of less than 9 Å³, or less than 8 Å³, or no more than 7 Å³, as determined by an X-ray powder diffraction.

The substrate is generally a ceramic or metal honeycomb structure having fine, parallel gas flow passages extending from one end of the structure to the other.

Metal materials useful for constructing the substrate may include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt % of the alloy. e.g. 10 to 25 wt % of chromium, 3 to 8% of aluminium, and up to 20 wt % of nickel. The alloys may also contain small or trace amounts of one or more metals such as manganese, copper, vanadium, titanium and the like. The surface of the metal substrate may be oxidized at high temperature, e.g., 1000° C. and higher, to form an oxide layer on the surface of the substrate, improving the corrosion resistance of the alloy and facilitating adhesion of the washcoat layer to the metal surface.

Ceramic materials useful for constructing the substrate may include any suitable refractory material, e.g., cordierite, mullite, cordierite-alumina, silicon nitride, zircon mullite, spodumene, alumina-silica-magnesia, zircon silicate, sillimanite, magnesium silicates, zircon, petalite, alumina, and aluminosilicates.

Within the context of the present invention, a monolithic flow-through substrate is preferred, which has a plurality of fine, parallel gas flow passages extending from an inlet to an outlet of the substrate such that passages are open to fluid flow therethrough. The passages, which are essentially straight paths from their fluid inlet to their fluid outlet, are defined by walls on which the catalytic material is applied as a washcoat so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain from 60 to 900 or more gas inlet openings (i.e., cells) per square inch of cross section. For example, the substrate may have from about 400 to 900, more usually from 600 to 750, cells per square inch (“cpsi”). The wall thickness of flow-through substrates may vary, with a typical range from 2 mils to 0.1 inches.

It is also possible that the substrate is a wall-flow substrate having a plurality of fine, parallel gas flow passages extending along from an inlet to an outlet face of the substrate wherein alternate passages are blocked at opposite ends. The configuration requiring the gas stream flow through the porous walls of the wall-flow substrate to reach the outlet face. The wall-flow substrates may contain up to about 700 cells per square inch (cpsi), for example 100 to 700 cpsi, typically 200 to 300 cpsi. The cross-sectional shape of the cells can vary as described above. The wall thickness of wall-flow substrates may vary, with a typical range from 2 mils to 0.1 inches.

The copper-containing small pore zeolites may be deposited on the substrate directly or indirectly (i.e. without or with no intermediate deposition), typically in the form of washcoat.

Herein, reference to “on the substrate” or similar expression means not only the surface of the substrate, for example the surface of the channel walls of the substrate, but also the internal pores in the channel walls in some cases.

The term “washcoat” has its usual meaning in the art and refers to a thin, adherent coating of a catalytic or other material applied to a substrate. A washcoat is generally formed by preparing a slurry containing a certain solid content (e.g., 15-60% by weight) of particles in a liquid vehicle, which is then applied onto a substrate, dried and calcined to provide a washcoat layer.

Generally, the washcoat may also comprise a binder, for example one or more selected from the group consisting of alumina, boehmite, silica, titania and zirconia. When present, the binder is typically comprised in an amount of 0.5 to 15.0 wt % of the total washcoat loading.

In some embodiments, the SCR catalytic article according to the present invention may comprise a substrate on which two or more different washcoat zones are carried. In these embodiments, the copper-containing small pore zeolite may be present in one or more washcoat zones on the substrate.

The copper-containing small pore zeolites useful in the present invention preferably has an atomic S/Cu ratio upon sulfurization and desulfurization of less than 0.15, for example 0.1 or less, as measured by ICP analysis.

It has been surprisingly found that the SCR catalytic article according to the present invention may have a NOx conversion recovery ratio at 200° C. upon sulfurization and desulfurization of at least 70%, for example at least 75%, or at least 80%, or even more than 80%.

According to a further aspect of the present invention, an exhaust treatment system is provided, which comprises
an internal combustion engine, for example a gasoline engine or a diesel engine; and
the SCR catalytic article comprising a substrate and thereon a copper-containing small pore zeolite as described hereinabove, located downstream of and in flow communication with the engine.

In some embodiments, the exhaust treatment system may comprise one or more other catalytic articles upstream or downstream from the SCR catalytic article according to the present invention. For example, the one or more other catalytic articles may be a catalyzed soot filter (CSF), a diesel oxidation catalyst (DOC) and/or another SCR catalytic article.

According to another aspect of the present invention, a method for treating an exhaust stream comprising NOx is provided, which includes contacting the exhaust stream with the SCR catalytic article or the exhaust treatment system as described herein.

According to a further aspect of the present invention, a method for determining whether a metal-promoted small pore zeolite is resistant to irreversible sulfur poisoning is provided, which comprises
preparation by applying the metal promoted small pore zeolite onto a substrate to provide a SCR catalytic article;
sulfurization by passing a gas stream containing 35 ppmv SO₂, 350 ppmv NO, 10 vol % O₂, 10 vol % H₂O and balanced N₂ through a Pt-containing diesel oxidation catalyst under an inlet temperature of 650° C. for partially oxidizing SO₂ to provide a SO₂ to SO₃ ratio of 30:70 and then through the SCR catalytic article under an outlet temperature of 400° C., at a space velocity of 10,000 hr⁻¹ based on the volume of the SCR catalytic article, for a period to provide a sulfurized SCR catalytic article with 40 g/L of S exposure based on the volume the SCR catalytic article, wherein the SCR catalytic article has been hydrothermally aged prior to the sulfurization;
desulfurization by passing a gas stream containing 10 vol % O₂, 8 vol % H₂O, 7 vol % CO₂ and balanced N₂ through the sulfurized SCR catalytic article at a space velocity of 60,000 h⁻¹ at 550° C. for 30 minutes; and
determination of the unit cell volumes of the metal promoted small pore zeolite before sulfurization and after desulfurization by an X-ray powder diffraction,
   wherein the metal promoted small pore zeolite is resistant to irreversible sulfur poisoning if the unit cell volume of the metal promoted small pore zeolite after desulfurization is lower than the unit cell volume thereof before sulfurization by less than 10 Å³.

According to yet another aspect of the present invention, a method for evaluating whether a metal-promoted small pore zeolite is qualified for resistance to irreversible sulfur poisoning is provided, which includes
providing a catalytic article comprising a substate and thereon a reference metal promoted small pore zeolite which has a minimum qualified NOx conversion recovery ratio, for example 70% or higher, upon sulfurization and desulfurization:

$$NOx Conversion Recovery Ratio ( \% ) = \frac{NOx Conversion after Desulfurization \times 100 \%}{NOx Conversion prior to Sulfurization}$$

determining the unit cell volume variation of the reference metal promoted small pore zeolite before sulfurization and after desulfurization by an X-ray powder diffraction, which is referred to as a predetermined value of unit cell volume variation;
preparing a catalytic article comprising a substate and thereon the metal promoted small pore zeolite to be evaluated;
determining the unit cell volume variation of the metal promoted small pore zeolite before sulfurization and after desulfurization at the same conditions as those for the catalytic article comprising a reference metal promoted small pore zeolite by the X-ray powder diffraction;
comparing the variation of the unit cell volume of the metal promoted small pore zeolite with the predetermined value,
   wherein the metal promoted small pore zeolite is evaluated as qualified for the resistance to irreversible sulfur poisoning if the unit cell volume variation thereof is no more than the predetermined value.

The term “sulfurization” here refers to the process for exposing a catalytic article comprising the metal-promoted small pore zeolite to a gas stream comprising sulfur oxides such as SO₂ or a combination of SO₂ and SO₃ to accumulate sulfur species in the catalytic article. Accordingly, the term “desulfurization” here refers to the process for removing sulfur species from a catalytic article under thermal conditions. Herein, the sulfur species in the catalytic article to be removed may be in form of sulfur (S²⁻), elemental sulfur (S°), sulfite (SO₃²⁻), and sulfate (SO₄²⁻); and the sulfur species removed from the catalytic article may be in the form of sulfur dioxide (SO₂), sulfur trioxide (SO₃), or sulfuric acid (H₂SO₄).

The method for determining whether a metal-promoted small pore zeolite is resistant to irreversible sulfur poisoning and the method for evaluating whether a metal-promoted small pore zeolite is qualified for the resistance to irreversible sulfur poisoning may also be referred to as the method for judging the resistance to irreversible sulfur poisoning for short. The method for judging the resistance to irreversible sulfur poisoning is applicable for any metal-promoted small pore zeolites useful as the SCR catalyst, for example copper-promoted small pore zeolites.

The metal is intentionally added to a small pore zeolite to promote the catalytic activity compared to the zeolite that do not have the intentionally added metal. The metal, also referred to as promoter, is generally incorporated into the small pore zeolite using ion-exchange processes or incipient wetness processes. Therefore, these ion-exchanged small pore zeolites are often referred to as “metal-promoted”.

As suitable candidates of the metal-promoted small pore zeolites for the method for judging the resistance to irreversible sulfur poisoning, the copper-containing small pore zeolites as described herein for the first one aspect of the present invention may be mentioned. Any description and preferences described for the copper-containing small pore zeolites may be applied by reference in the method for judging the resistance to irreversible sulfur poisoning.

The minimum qualified NOx conversion recovery ratio upon sulfurization and desulfurization may be set to any values, for example 70% or higher, such as 75%, 76%, 77%, 78%, 79%, 80%, 81%, 82%, 83% or even higher, according to the practical requirement of the resistance of the metal-promoted small pore zeolite to irreversible sulfur poisoning. The minimum qualified NOx conversion recovery ratio may be determined at a predetermined temperature which may be encountered in an exhaust gas, particularly 200° C.

### EMBODIMENTS

Various embodiments are listed below. It will be understood that the embodiments listed below may be combined with all aspects and other embodiments in accordance with the scope of the invention.

1. A SCR catalytic article, comprising
a substrate and thereon
a copper-containing small pore zeolite, having a crystal structure characterized by a decrease of unit cell volume upon sulfurization and desulfurization of less than 10 Å³, as determined by an X-ray powder diffraction,
wherein
the sulfurization is carried out by passing a gas stream containing 35 ppmv SO₂, 350 ppmv NO, 10 vol % O₂, 10 vol % H₂O and balanced N₂ through a Pt-containing diesel oxidation catalyst (DOC) under an inlet temperature of 650° C. for partially oxidizing SO₂ to provide a SO₂ to SO₃ ratio of 30:70 and then through the SCR catalytic article under an outlet temperature of 400° C., at a space velocity of 10,000 hr′ based on the volume of the SCR catalytic article, for a period to provide 40 g/L of S exposure based on the volume of the SCR catalytic article, wherein the SCR catalytic article has been hydrothermally aged prior to the sulfurization; and
the desulfurization is carried out by passing a gas stream containing 10 vol % O₂, 8 vol % H₂O, 7 vol % CO₂ and balanced N₂ through the SCR catalytic article having been subjected to the sulfurization at a space velocity of 60,000 h⁻¹ at 550° C. for 30 minutes.

2. The SCR catalytic article according to embodiment 1, wherein the small pore zeolite has a crystal structure characterized by a decrease of unit cell volume upon sulfurization and desulfurization of less than 9 Å³, or less than 8 Å³, or no more than 7 Å³.

3. The SCR catalytic article according to embodiment 1 or 2, wherein the small pore zeolite is a small pore 8-ring zeolite, for example having framework types AEI, AFT, AFX, CHA, EAB, EMT, ERI, FAU, GME, JSR, KFI, LEV, LTL, LTN, MOZ, MSO, MVWV, OFF, SAS, SAT, SAV, SBS, SBT, SFW, SSF, SZR, TSC and WEN.

4. The SCR catalytic article according to any of preceding embodiments, wherein the small pore zeolite has a framework type selected from the group consisting of AEI, AFT, AFX, CHA, EAB, ERI, KFI, LEV, SAS, SAT and SAV, particularly selected from the group consisting of AEI, AFT, AFX and CHA, preferably CHA.

5. The SCR catalytic article according to any of preceding embodiments, wherein the small pore zeolite is selected from aluminosilicate zeolites, particularly having a silica to alumina molar ratio in the range of 2 to 300, for example 5 to 250, 5 to 200, 5 to 100, or 5 to 60.

6. The SCR catalytic article according to any of preceding embodiments, wherein the small pore zeolite is selected from aluminosilicate zeolites having the CHA framework type, and has a silica to alumina ratio in the range of 5 to 60, for example 10 to 60, 11 to 50, 11 to 40, or 12 to 35.

7. The SCR catalytic article according to any of preceding embodiments, wherein the small pore zeolites has an average crystal size in the range of 0.05 to 5 microns, 0.05 to 1 microns, 0.5 to 2 microns, or 0.8 micron to 1.5 microns, as measured by scanning electron microscopy.

8. The SCR catalytic article according to any of preceding embodiments, wherein the copper-containing small pore zeolite has a Cu content of at least about 0.1 wt %, for example in the range of 0.1 wt % to 20 wt %, 0.5 wt % to 17 wt %, 2 wt % to 15 wt %, 2 wt % to 10 wt %, or 2 wt % to 7 wt %, calculated as CuO and based on the total weight of the copper-containing small pore zeolite on a volatile-free basis.

9. The SCR catalytic article according to any of preceding embodiments, wherein the copper-containing small pore zeolite has a copper to framework aluminium molar ratio in the range of 0.1 to 0.5, for example 0.25 to 0.5 or 0.30 to 0.50.

10. The SCR catalytic article according to any of preceding embodiments, wherein the copper-containing small pore zeolite has an atomic S/Cu ratio upon sulfurization and desulfurization of less than 0.15, for example 0.1 or less.

11. The SCR catalytic article according to any of preceding embodiments, wherein the substrate is a wall-flow substrate or a flow-through substrate.

12. The SCR catalytic article according to any of preceding embodiments, wherein the copper-containing small pore zeolite is deposited on the substrate directly or indirectly, typically in the form of washcoat.

13. The SCR catalytic article according to any of preceding embodiments, wherein the SCR catalytic article has a NOx conversion recovery ratio at 200° C. upon sulfurization and desulfurization of at least 70%, at least 75%, at least 80%, or even more than 80%.

14. A SCR catalytic article, comprising
a substrate and thereon
a copper-containing small pore zeolite, having a NOx conversion recovery ratio at 200° C. upon sulfurization and desulfurization of at least 70%, at least 75%, at least 80%, or even more than 80%,
wherein
the sulfurization is carried out by passing a gas stream containing 35 ppmv SO₂, 350 ppmv NO, 10 vol % O₂, 10 vol % H₂O and balanced N₂ through a Pt-containing diesel oxidation catalyst (DOC) under an inlet temperature of 650° C. for partially oxidizing SO₂ to provide a SO₂ to SO₃ ratio of 30:70 and then through the SCR catalytic article under an outlet temperature of 400° C., at a space velocity of 10,000 hr⁻¹ based on the volume of the SCR catalytic article, for a period to provide 40 g/L of S exposure based on the volume of the SCR catalytic article, wherein the SCR catalytic article has been hydrothermally aged prior to the sulfurization; and
the desulfurization is carried out by passing a gas stream containing 10 vol % O₂, 8 vol % H₂O, 7 vol % CO₂ and balanced N₂ through the SCR catalytic article having been subjected to the sulfurization at a space velocity of 60,000 h⁻¹ at 550° C. for 30 minutes.

15. An exhaust treatment system, comprising
an internal combustion engine, for example a gasoline engine or a diesel engine; and
the SCR catalytic article as defined in any of preceding embodiments, located downstream of and in flow communication with the engine.

16. A method for treating an exhaust stream comprising NOx, including contacting the exhaust stream with the SCR catalytic article defined in any of preceding embodiments 1 to 14 or the exhaust treatment system as defined in embodiment 15.

17. Use of the copper-containing small pore zeolite as defined in any of preceding embodiments 1 to 14 as a SCR catalyst.

18. A method for determining whether a metal-promoted small pore zeolite is resistant to irreversible sulfur poisoning, which comprises
preparation by applying the metal promoted small pore zeolite onto a substrate to provide a SCR catalytic article;
sulfurization by passing a gas stream containing 35 ppmv SO₂, 350 ppmv NO, 10 vol % O₂, 10 vol % H₂O and balanced N₂ through a Pt-containing diesel oxidation catalyst under an inlet temperature of 650° C. for partially oxidizing SO₂ to provide a SO₂ to SO₃ ratio of 30:70 and then through the SCR catalytic article under an outlet temperature of 400° C., at a space velocity of 10,000 hr⁻¹ based on the volume of the SCR catalytic article, for a period to provide a sulfurized SCR catalytic article with 40 g/L of S exposure based on the volume the SCR catalytic article, wherein the SCR catalytic article has been hydrothermally aged prior to the sulfurization;
desulfurization by passing a gas stream containing 10 vol % O₂, 8 vol % H₂O, 7 vol % CO₂ and balanced N₂ through the sulfurized SCR catalytic article at a space velocity of 60,000 h⁻¹ at 550° C. for 30 minutes; and
determination of the unit cell volumes of the metal promoted small pore zeolite before sulfurization and after desulfurization by an X-ray powder diffraction,
wherein the metal promoted small pore zeolite is resistant to irreversible sulfur poisoning if the unit cell volume of the metal promoted small pore zeolite after desulfurization is lower than the unit cell volume thereof before sulfurization by less than 10 Å³, preferably less than 9 Å³, or less than 8 Å³, or no more than 7 Å³.

19. A method for evaluating whether a metal-promoted small pore zeolite is qualified for resistance to irreversible sulfur poisoning, which includes
providing a catalytic article comprising a substate and thereon a reference metal promoted small pore zeolite which has a minimum qualified NOx conversion recovery ratio, for example 70% or higher, upon sulfurization and desulfurization:

$$NOx Conversion Recovery Ratio ( \% ) = \frac{NOx Conversion after Desulfurization \times 100 \%}{NOx Conversion prior to Sulfurization}$$

determining the unit cell volume variation of the reference metal promoted small pore zeolite before sulfurization and after desulfurization by an X-ray powder diffraction, which is referred to as a predetermined value of unit cell volume variation;
preparing a catalytic article comprising a substate and thereon the metal promoted small pore zeolite to be evaluated;
determining the unit cell volume variation of the metal promoted small pore zeolite before sulfurization and after desulfurization at the same conditions as those for the catalytic article comprising a reference metal promoted small pore zeolite by the X-ray powder diffraction;
comparing the variation of the unit cell volume of the metal promoted small pore zeolite with the predetermined value,
   wherein the metal promoted small pore zeolite is evaluated as qualified for the resistance to irreversible sulfur poisoning if the unit cell volume variation thereof is no more than the predetermined value.

20. The method according to embodiment 19, wherein the metal promoted small pore zeolite is selected from iron-promoted small pore zeolites and copper-promoted small pore zeolites, particularly copper-promoted small pore zeolites, for example the copper-containing small pore zeolite as defined in any of embodiments 1 to 9.

21. The method according to embodiment 19 or 20, wherein the minimum qualified NOx conversion recovery ratio upon sulfurization and desulfurization is 75%, 76%, 77%, 78%, 79%, 80%, 81%, 82%, 83% or even higher.

22. The method according to any of embodiments 19 to 21, wherein the minimum qualified NOx conversion recovery ratio is determined at 200° C.

23. The method according to embodiment 19 to 22, wherein
the sulfurization is carried out by passing a gas stream containing 35 ppmv SO₂, 350 ppmv NO, 10 vol % O₂, 10 vol % H₂O and balanced N₂ through a Pt-containing diesel oxidation catalyst (DOC) under an inlet temperature of 650° C. for partially oxidizing SO₂ to provide a SO₂ to SO₃ ratio of 30:70 and then through the SCR catalytic article under an outlet temperature of 400° C., at a space velocity of 10,000 hr⁻¹ based on the volume of the SCR catalytic article, for a period to provide 40 g/L of S exposure based on the volume of the SCR catalytic article, wherein the catalytic article has been hydrothermally aged prior to the sulfurization; and
the desulfurization is carried out by passing a gas stream containing 10 vol % O₂, 8 vol % H₂O, 7 vol % CO₂ and balanced N₂ through the SCR catalytic article having been subjected to the sulfurization at a space velocity of 60,000 h⁻¹ at 550° C. for 30 minutes.

### EXAMPLES

Aspects of the present invention are more fully illustrated by the following examples, which are set forth to illustrate certain aspects of the present invention and are not to be construed as limiting thereof.

### I. Preparation Examples

### Example 1 Preparation of a Catalytic Article Comprising Cu/SSZ-13 Powder (SAR=30, CuO %=3.25 wt %)

The SSZ-13 was crystallized using trimethyladamantyl ammonium hydroxide (TMAdaOH) as the template and sodium hydroxide as further source of OH⁻. The synthesis gel had a composition with the following molar ratios:
36 SiO₂:1.2 Al₂O₃:2.6 (TMAdaOH):3.6 NaOH:379 H₂O.

After the hydrothermal crystallization at 170° C. for 40 hours, the suspension was filtered, dried, and calcined at 600° C. A sample of the calcined material was examined via XRD and confirmed the zeolite having CHA framework. ICP analysis of the obtained Na-form of SSZ-13 showed the material to have a SiO₂ to Al₂O₃ ratio (SAR) of 30.

To a stirred tank, deionized water (78 kg) was added and heated to 60° C. with agitation, and then copper acetate monohydrate (1.56 kg) was added. Once copper acetate monohydrate was fully dissolved, Na/SSZ-13 (12 kg) was added to the tank and mixing was continued for 2 hours at 60° C. The suspension was transferred to a plate and frame filter press for removal of supernatant. The solid Cu/SSZ-13 was washed with deionized water until filtrate conductivity was below 200 microsiemens, and then air-dried on the filter press. The copper loading as measured by ICP was 3.25 wt % as CuO, based on the total weight of the zeolite on a volatile-free basis.

95 parts by weight of the obtained Cu/SSZ-13 and 5 parts by weight of zirconium acetate calculated as ZrO₂ were mixed in a weight ratio of 95:5 into deionized water to form a slurry. The slurry was then milled to a particle size of D₉₀ between 7 to 10 μm, as measured with a Sympatec particle size analyser. The milled slurry was coated onto a flow-through cordierite monolith substrate having a cell density of 600 cpsi and a wall thickness of 3 mil, followed by drying at 130° C. and calcination at 450° C. The washcoat loading was 2.0 g/in³.

### Example 2 Preparation of a Catalytic Article Comprising Cu/SSZ-13 Powder (SAR=19, CuO %=5.0 wt %)

SSZ-13 was crystallized using trimethyladamantyl ammonium hydroxide (TMAdaOH) as the template, and the synthesis gel had a composition with the following molar ratios:
20 SiO₂:1.0 Al₂O₃:1.42 TMAdaOH:2.6 NaOH:220 H₂O.

After the hydrothermal crystallization at 170° C. for 30 hours, the suspension was filtered, dried, and calcined at 540° C. for 6 hours to yield the Na⁺ form of SSZ-13 as characterized by XRD. ICP analysis of the obtained Na-form of SSZ-13 showed the material to have a SiO₂ to Al₂O₃ ratio (SAR) of 19. Following calcination, the Na⁺ form of SSZ-13 was exchanged to NH₄⁺ form of SSZ-13 with a Na content of <500 ppm as Na₂O.

The NH₄⁺-form of SSZ-13 zeolite (12 kg) was added to 66 kg of deionized water in a stirred reactor at room temperature. The reactor was heated to 60° C. in 30 minutes. Copper acetate monohydrate (4.67 kg, 23.38 moles) was added, along with acetic acid (96 g, 1.6 moles). Mixing was continued for 60 minutes while maintaining a reaction temperature of 60° C. The reactor contents were transferred to a plate and frame filter press. The solid Cu/SSZ13 was washed with deionized water until filtrate conductivity was below 200 microsiemens, and then air-dried on the filter press. The copper loading as measured by ICP was 5 wt % as CuO, based on the total weight of the zeolite.

95 parts by weight of the obtained Cu/SSZ-13 and 5 parts by weight of zirconium acetate calculated as ZrO₂ were mixed into deionized water to form a slurry, which was milled to a particle size of D₉₀ between 7 to 10 μm, as measured with a Sympatec particle size analyser. The milled slurry was coated onto a flow-through cordierite monolith substrate having a cell density of 600 cpsi and a wall thickness of 3 mil, followed by drying at 130° C. and calcination at 450° C. The washcoat loading was 2.75 g/in³.

### Example 3 Preparation of a Catalytic Article Comprising Cu/SSZ-13 Powder (SAR=18, CuO %=5.6 wt %)

SSZ-13 was crystallized using trimethyladamantyl ammonium hydroxide (TMAdaOH) as the template, and the synthesis gel had a composition with the following molar ratios:
35 SiO₂:1.0 Al₂O₃:3.15 TMAdaOH:28.7 Na:17.5 OH:1120 H₂O.

After the hydrothermal crystallization at 140° C. for 42 hours, the suspension was filtered, dried and calcined at 540° C. for 6 hours to yield the Na⁺ form of SSZ-13 as characterized by XRD. ICP analysis of the obtained Na-form of SSZ-13 showed the material to have a SiO₂ to Al₂O₃ ratio (SAR) of 18. Following calcination, the Na-form of SSZ-13 was exchanged to NH₄⁺-form of SSZ-13 with a Na content of <500 ppm as Na₂O, which was then calcined at 450° C. for 6 hours to yield the hydrogen-form of SSZ-13.

85.4 parts by weight of the hydrogen-form of SSZ-13, 5.1 parts by weight of CuO and 4.8 parts by weigh of zirconium acetate calculated as ZrO₂ were mixed into deionized water to form a slurry. The slurry was milled to a particle size of D₉₀ between 4 to 6 μm, as measured with a Sympatec particle size analyser. The slurry was mixed for 24 hours at room temperature to allow copper ions to exchange into the zeolite framework. Non-dispersible Boehmite alumina in an amount of 4.8 wt % of total slurry solid was mixed into the slurry. The final slurry was coated onto a flow-through cordierite monolith substrate having a cell density of 600 cpsi and a wall thickness of 3 mil, followed by drying at 130° C. and calcination at 550° C. The washcoat loading was 2.9 g/in³.

### Example 4 Preparation of a Catalytic Article Comprising Cu/SSZ-13 Powder (SAR=10, CuO %=6.8%)

SSZ-13 was crystallized using trimethyladamantyl ammonium hydroxide (TMAdaOH) as the template, and the synthesis gel had a composition with the following molar ratios:
35 SiO₂:1.0 Al₂O₃:1.03 TMAdaOH:28.4 Na:24.2 OH:423.5 H₂O.

After the hydrothermal crystallization at 140° C. for 24 hours, the suspension was filtered, dried and calcined at 540° C. for 6 hours to yield the Na⁺ form of SSZ-13 as characterized by XRD. ICP analysis of the obtained Na-form of SSZ-13 showed the material to have a SiO₂ to Al₂O₃ ratio (SAR) of 10. Following calcination, the Na⁺ form of SSZ-13 was exchanged to NH₄⁺ form of SSZ-13 with a Na content of <1000 ppm as Na₂O, which was calcined at 450° C. for 6 hours to yield the hydrogen-form of SSZ-13.

84.3 parts by weight of the hydrogen-form of SSZ-13, 6.2 parts by weight of CuO and 4.8 parts by weight of zirconium acetate calculated as ZrO₂ were mixed into deionized water to form a slurry. The slurry was milled to a particle size of D₉₀ between 7 to 10 μm, as measured with a Sympatec particle size analyser. The slurry was mixed for 24 hours at room temperature to allow copper ions to exchange into the zeolite framework. Non-dispersible Boehmite alumina in an amount of 2.4 wt % of total slurry solid and dispersible Boehmite alumina in an amount of 2.4 wt % of total slurry solid were mixed into the slurry. The final slurry was coated onto a flow-through cordierite monolith substrate having a cell density of 600 cpsi and a wall thickness of 3 mil, followed by drying at 130° C. and calcination at 550° C. The washcoat loading was 2.9 g/in³.

### Example 5 Preparation of a Pt-Containing Diesel Oxidation Catalyst (DOC)

A doped 5% SiO₂—Al₂O₃ material was incipient wetness impregnated with a diluted tetraamineplatinum(II) hydroxide complex solution, and the resulting material was added into deionized (DI) water to form a slurry suspension. The pH of the slurry suspension was adjusted to 4-5 with diluted HNO₃. The slurry was milled to D₉₀=12-15 um, and an alumina binder material in an amount of 2.5 wt % based on the total slurry solid was added. The slurry was then coated at 30-45% solid content onto a flow-through honeycomb substrate having a cell density of 400 cpsi and a wall thickness of 4 mil. After drying, the catalyst was calcined at 590° C. for 1 hour in air. The washcoat loading was 1.037 g/in³, and the Pt loading was 10 g/ft³.

### II. Measurements and Tests

### II.1 Sulfurization and Desulfurization

### Sulfurization

A Pt-containing Diesel Oxidation Catalyst (DOC) as prepared in Example 5 was placed upstream of a SCR catalyst. The SCR catalyst had been hydrothermally aged at 650° C. with an atmosphere containing 10 vol % H₂O, 10 vol % O₂ and balance of N₂ at a flow rate of 20 L/min for 100 hours. A gas stream containing 35 ppmv SO₂, 350 ppmv NO, 10 vol % O₂, 10 vol % H₂O and balanced N₂ at 10,000 hr⁻¹ space velocity based on the volume of the SCR catalyst was passed through the DOC and the SCR catalyst. The inlet temperature of the DOC catalyst was maintained at 650° C. and the outlet temperature of the SCR catalyst was maintained at 400° C. SO₂ contained in the gas stream was oxidized to SO₃ at a SO₂ to SO₃ ratio of 30:70 upon flowing through the DOC. The gas stream was continued for a period of time to produce 40 g/L of S exposure based on the volume of SCR, to provide a sulfurized SCR catalyst.

### Desulfurization

A gas stream containing 10 vol % O₂, 8 vol % H₂O, 7 vol % CO₂ and balanced N₂ was passed through the sulfurized SCR catalyst at a space velocity of 60,000 h⁻¹, 550° C. for 30 minutes, to provide a desulfurized SCR catalyst.

### II.2 Measurements

### Unit Cell Volume (UCV)

Unit cell volume was measured by X-ray powder diffraction (XRD). The washcoat was removed from the substrate of each SCR catalyst article using a tungsten needle. The powder was then ground using a mortar and pestle. The ground powder was then front packed onto Si⁰ low background wafers for analysis. A θ-θ PANalytical X'Pert Pro MPD X-ray diffraction system was used to collect data in Bragg-Brentano geometry. The optical path consisted of the X-ray tube, 0.04 rad soller slit, ⅛° divergence slit, 15 mm beam mask, ¼° anti-scatter slit, beamknife over sample, ⅛° anti-scatter slit, 0.04 rad soller slit, Ni⁰ filter, and a X'Celerator linear position sensitive detector with a 2.122° active length. Cu K_{α} radiation was used in the analysis with generator settings of 45 kV and 40 mA. X-ray diffraction data was collected from 3° to 70° 2θ using a step size of 0.017° and a count time of 60 s per step. Phase identification was done using Jade software while quantification was done using Topas software.

### Zeolitic Surface Area (ZSA)

Zeolitic Surface area (ZSA) is a measure of the micropore surface area (pores ≤2 nm in diameter), and is expressed in m²/g which means zeolitic surface area (m²) per gram of catalyst article including washcoat and substrate. The ZSA was measured by BET N₂ adsorption as described in detail in U.S. Provisional Patent Application 62/517,243, which is incorporated herein by reference in its entirety. The catalytic articles were measured without removing coatings from the substrate and without crushing the catalyst article before analysis.

### Atomic S/Cu Ratio

The atomic S/Cu ratio of the copper-containing small pore zeolite upon sulfurization and desulfurization is also a measure of irreversible sulfur poisoning, which is determined by measuring the contents of the S and Cu through ICP analysis on crushed catalyst articles and then calculating the atomic ratio thereof.

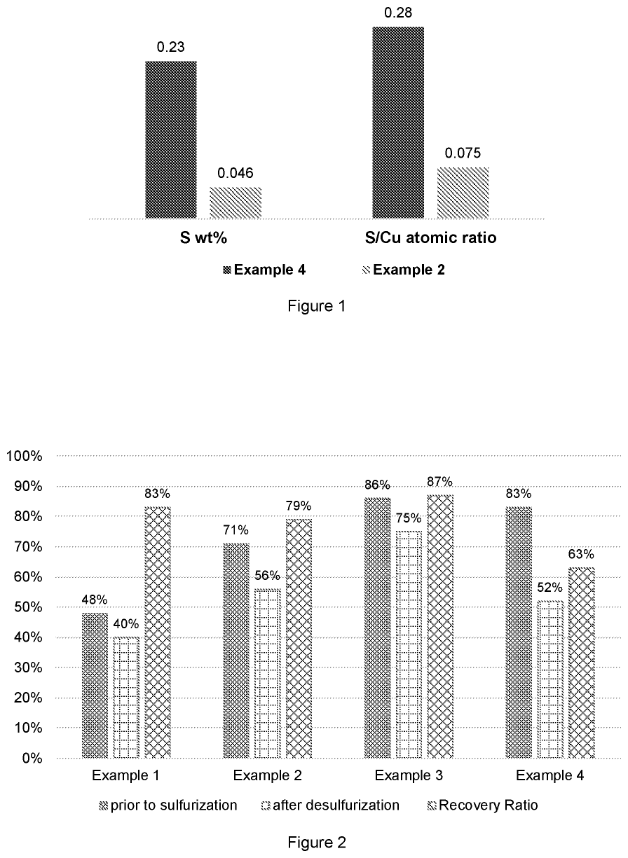

The results of the unit cell volume and zeolitic surface area measurements prior to sulfurization (Pre) and post desulfurization (Post), and the atomic S/Cu ratio are summarized in the Table 1 below. The atomic S/Cu ratios as determined for the Cu/SSZ-13 zeolites of Example 2 and Example 4 are also shown in FIG. 1.

TABLE 1

| | | Δ(UCV) | | Δ(ZSA) | atomic |
|---|---|---|---|---|---|
| Sample | UCV (Å³) | (Å³) | ZSA (m²/g) | (m²/g) | S/Cu ratio |
| Example 1 | Pre: 2364 | 0 | Pre: 105 | 2 | not |
| | Post: 2364 | | Post: 103 | | measured |
| Example 2 | Pre: 2378 | 5 | Pre: 177 | 5 | 0.075 |
| | Post: 2373 | | Post: 172 | | |
| Example 3 | Pre: 2387 | 7 | not | not | not |
| | Post: 2380 | | measured | measured | measured |
| Example 4 | Pre: 2399 | 13 | Pre: 152 | 2 | 0.28 |
| | Post: 2386 | | Post: 150 | | |

II.3 Test of NOx Conversion

The NOx conversion was tested using a flow reactor under pseudo-steady state conditions at a temperature of 200° C. with a gas stream of 1000 ppmv NO, 1050 ppmv NH₃, 10 vol % O₂, 8 vol % H₂O, 7 vol % CO₂ and balanced N₂, at a space velocity of 60,000 h⁻¹. NOx conversion is reported as mol % and measured as NO and NO₂.

NOx conversion recovery ratio upon the sulfurization and desulfurization processes was calculated in accordance with the following equation:

$$NOx Conversion Recovery Ratio ( \% ) = \frac{NOx Conversion after Desulfurization \times 100 \%}{NOx Conversion prior to Sulfurization}$$

The NOx conversions and NOx conversion Recovery ratios are summarized in the Table 2 below.

TABLE 2

| | | NOx | NOx | |
|---|---|---|---|---|
| | | conversion @ | conversion @ | |
| | | 200° C. | 200° C. | NOx Conversion |
| | Δ(UCV) | prior to | after | Recovery |
| Sample | (Å³) | sulfurization | desulfurization | Ratio (%) |
| Example 1 | 0 | 48 | 40 | 83 |
| Example 2 | 5 | 71 | 56 | 79 |
| Example 3 | 7 | 86 | 75 | 87 |
| Example 4 | 13 | 83 | 52 | 63 |

As shown in Table 2, the catalytic articles from Examples 1 to 3 have significantly higher NOx conversion recovery ratios than the catalytic article from Example 4 upon the sulfurization and desulfurization, which indicates a much better resistance to the irreversible sulfur poisoning. The results were also illustrated graphically in FIG. 2.

The SCR catalyst from Example 4 was further tested for the NOx conversion recovery ratio upon the same sulfurization and desulfurization as described hereinabove except that the desulfurization was carried out at 700° C. The higher desulfurization temperature may be helpful to remove the sulfur species from the Cu-CHA zeolite more sufficiently. However, it was found that the NOx conversion recovery ratio was improved to 72%, which is still lower than that of Example 1 to 3 with desulfurization at 550° C.

Without being bound to any particular theory, it is believed that the improved resistance to the irreversible sulfur poisoning could be attributed to the less decrease of unit cell volume of the Cu-CHA zeolites of Examples 1 to 3 upon sulfurization and desulfurization.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A SCR catalytic article, comprising
a substrate and thereon
a copper-containing small pore zeolite, having a crystal structure characterized by a decrease of unit cell volume upon sulfurization and desulfurization of less than 10 Å³, as determined by an X-ray powder diffraction,
wherein
the sulfurization is carried out by passing a gas stream containing 35 ppmv SO₂, 350 ppmv NO, 10 vol % O₂, 10 vol % H₂O and balanced N₂ through a Pt-containing diesel oxidation catalyst (DOC) under an inlet temperature of 650° C. for partially oxidizing SO₂ to provide a SO₂ to SO₃ ratio of 30:70 and then through the SCR catalytic article under an outlet temperature of 400° C., at a space velocity of 10,000 hr⁻¹ based on the volume of the SCR catalytic article, for a period to provide 40 g/L of S exposure based on the volume of the SCR catalytic article, wherein the SCR catalytic article has been hydrothermally aged prior to the sulfurization; and
the desulfurization is carried out by passing a gas stream containing 10 vol % O₂, 8 vol % H₂O, 7 vol % CO₂ and balanced N₂ through the SCR catalytic article having been subjected to the sulfurization at a space velocity of 60,000 h⁻¹ at 550° C. for 30 minutes.

2. The SCR catalytic article according to claim 1, wherein the small pore zeolite has a crystal structure characterized by a decrease of unit cell volume upon sulfurization and desulfurization of less than 9 Å³, or less than 8 Å³, or no more than 7 Å³.

3. The SCR catalytic article according to claim 1, wherein the small pore zeolite is a small pore 8-ring zeolite having framework types AEI, AFT, AFX, CHA, EAB, EMT, ERI, FAU, GME, JSR, KFI, LEV, LTL, LTN, MOZ, MSO, MVWV, OFF, SAS, SAT, SAV, SBS, SBT, SFW, SSF, SZR, TSC or WEN.

4. (canceled)

5. The SCR catalytic article according to claim 1, wherein the small pore zeolite is selected from aluminosilicate zeolites, particularly having a silica to alumina molar ratio in the range of 2 to 300, for example 5 to 250, 5 to 200, 5 to 100, or 5 to 60.

6. The SCR catalytic article according to claim 1, wherein the small pore zeolite is selected from aluminosilicate zeolites having the CHA framework type, and has a silica to alumina ratio in the range of 5 to 60, for example 10 to 60, 11 to 50, 11 to 40, or 12 to 35.

7. The SCR catalytic article according to claim 1, wherein the small pore zeolites has an average crystal size in the range of 0.05 to 5 microns, 0.05 to 1 microns, 0.5 to 2 microns, or 0.8 micron to 1.5 microns, as measured by scanning electron microscopy.

8. The SCR catalytic article according to claim 1, wherein the copper-containing small pore zeolite has a Cu content of at least about 0.1 wt %, for example in the range of 0.1 wt % to 20 wt %, 0.5 wt % to 17 wt %, 2 wt % to 15 wt %, 2 wt % to 10 wt %, or 2 wt % to 7 wt %, calculated as CuO and based on the total weight of the copper-containing small pore zeolite on a volatile-free basis.

9. The SCR catalytic article according to claim 1, wherein the copper-containing small pore zeolite has a copper to framework aluminium molar ratio in the range of 0.1 to 0.5, for example 0.25 to 0.5 or 0.30 to 0.50.

10. The SCR catalytic article according to claim 1, wherein the copper-containing small pore zeolite has an atomic S/Cu ratio upon sulfurization and desulfurization of less than 0.15, for example 0.1 or less.

11. The SCR catalytic article according to claim 1, wherein the substrate is a wall-flow substrate or a flow-through substrate.

12. The SCR catalytic article according to claim 1, wherein the copper-containing small pore zeolite is deposited on the substrate directly or indirectly, typically in the form of washcoat.

13. The SCR catalytic article according to claim 1, wherein the SCR catalytic article has a NOx conversion recovery ratio at 200° C. upon sulfurization and desulfurization of at least 70%, at least 75%, at least 80%, or even more than 80%.

14. A SCR catalytic article, comprising
a substrate and thereon
a copper-containing small pore zeolite, having a NOx conversion recovery ratio at 200° C. upon sulfurization and desulfurization of at least 70%,
wherein
the sulfurization is carried out by passing a gas stream containing 35 ppmv SO₂, 350 ppmv NO, 10 vol % O₂, 10 vol % H₂O and balanced N₂ through a Pt-containing diesel oxidation catalyst (DOC) under an inlet temperature of 650° C. for partially oxidizing SO₂ to provide a SO₂ to SO₃ ratio of 30:70 and then through the SCR catalytic article under an outlet temperature of 400° C., at a space velocity of 10,000 hr⁻¹ based on the volume of the SCR catalytic article, for a period to provide 40 g/L of S exposure based on the volume of the SCR catalytic article, wherein the SCR catalytic article has been hydrothermally aged prior to the sulfurization; and
the desulfurization is carried out by passing a gas stream containing 10 vol % O₂, 8 vol % H₂O, 7 vol % CO₂ and balanced N₂ through the SCR catalytic article having been subjected to the sulfurization at a space velocity of 60,000 h⁻¹ at 550° C. for 30 minutes.

15. An exhaust treatment system, comprising
an internal combustion engine; and
the SCR catalytic article as defined in claim 1, located downstream of and in flow communication with the engine.

16. A method for treating an exhaust stream comprising NOx, including contacting the exhaust stream with the SCR catalytic article defined in claim 1.

17. (canceled)

18. A method for determining whether a metal-promoted small pore zeolite is resistant to irreversible sulfur poisoning, which comprises
preparation by applying the metal promoted small pore zeolite onto a substrate to provide a SCR catalytic article;
sulfurization by passing a gas stream containing 35 ppmv SO₂, 350 ppmv NO, 10 vol % O₂, 10 vol % H₂O and balanced N₂ through a Pt-containing diesel oxidation catalyst under an inlet temperature of 650° C. for partially oxidizing SO₂ to provide a SO₂ to SO₃ ratio of 30:70 and then through the SCR catalytic article under an outlet temperature of 400° C., at a space velocity of 10,000 hr⁻¹ based on the volume of the SCR catalytic article, for a period to provide a sulfurized SCR catalytic article with 40 g/L of S exposure based on the volume the SCR catalytic article, wherein the SCR catalytic article has been hydrothermally aged prior to the sulfurization;
desulfurization by passing a gas stream containing 10 vol % O₂, 8 vol % H₂O, 7 vol % CO₂ and balanced N₂ through the sulfurized SCR catalytic article at a space velocity of 60,000 h⁻¹ at 550° C. for 30 minutes; and
determination of the unit cell volumes of the metal promoted small pore zeolite before sulfurization and after desulfurization by an X-ray powder diffraction,
wherein the metal promoted small pore zeolite is resistant to irreversible sulfur poisoning if the unit cell volume of the metal promoted small pore zeolite after desulfurization is lower than the unit cell volume thereof before sulfurization by less than 10 Å³, preferably less than 9 Å³, or less than 8 Å³, or no more than 7 Å³.

19. A method for evaluating whether a metal-promoted small pore zeolite is qualified for resistance to irreversible sulfur poisoning, which includes
providing a catalytic article comprising a substate and thereon a reference metal promoted small pore zeolite which has a minimum qualified NOx conversion recovery ratio of 70% or higher, upon sulfurization and desulfurization:
$$NOx Conversion Recovery Ratio ( \% ) = \frac{NOx Conversion after Desulfurization \times 100 \%}{NOx Conversion prior to Sulfurization}$$
determining the unit cell volume variation of the reference metal promoted small pore zeolite before sulfurization and after desulfurization by an X-ray powder diffraction, which is referred to as a predetermined value of unit cell volume variation;
preparing a catalytic article comprising a substate and thereon the metal promoted small pore zeolite to be evaluated;
determining the unit cell volume variation of the metal promoted small pore zeolite before sulfurization and after desulfurization at the same conditions as those for the catalytic article comprising a reference metal promoted small pore zeolite by the X-ray powder diffraction;
comparing the variation of the unit cell volume of the metal promoted small pore zeolite with the predetermined value,
wherein the metal promoted small pore zeolite is evaluated as qualified for the resistance to irreversible sulfur poisoning if the unit cell volume variation thereof is no more than the predetermined value.

20. The method according to claim 19, wherein the metal promoted small pore zeolite is selected from copper-promoted small pore zeolites.

21. The method according to claim 19, wherein the minimum qualified NOx conversion recovery ratio upon sulfurization and desulfurization is 75%.

22. (canceled)

23. The method according to claim 19, wherein
the sulfurization is carried out by passing a gas stream containing 35 ppmv SO₂, 350 ppmv NO, 10 vol % O₂, 10 vol % H₂O and balanced N₂ through a Pt-containing diesel oxidation catalyst (DOC) under an inlet temperature of 650° C. for partially oxidizing SO₂ to provide a SO₂ to SO₃ ratio of 30:70 and then through the catalytic article under an outlet temperature of 400° C., at a space velocity of 10,000 hr⁻¹ based on the volume of the SCR catalytic article, for a period to provide 40 g/L of S exposure based on the volume of the SCR catalytic article, wherein the catalytic article has been hydrothermally aged prior to the sulfurization; and
the desulfurization is carried out by passing a gas stream containing 10 vol % O₂, 8 vol % H₂O, 7 vol % CO₂ and balanced N₂ through the SCR catalytic article having been subjected to the sulfurization at a space velocity of 60,000 h⁻¹ at 550° C. for 30 minutes.
